(19) United States
(12) Patent Application Publication
(10) Pub. No.: US 2019/0251501 A1
(43) Pub. Date: Aug. 15, 2019

(54) SYSTEM AND METHOD FOR DYNAMIC HS CODE CLASSIFICATION THROUGH IMAGE ANALYSIS AND MACHINE LEARNING

(71) Applicant: Clint Reid, St. George, UT (US)

(72) Inventor: Clint Reid, St. George, UT (US)

(21) Appl. No.: 16/275,138

(22) Filed: Feb. 13, 2019

Related U.S. Application Data
(60) Provisional application No. 62/630,233, filed on Feb. 13, 2018.

(51) Int. Cl. G06Q 10/08

(52) U.S. Cl. CPC G06Q 10/0831; G06N 20/00; G06Q 10/08345

(57) ABSTRACT

A system for dynamic classification of harmonized codes has a harmonization server in communication with a merchant server, the harmonization server receiving and processing customer information and product information from the merchant server; based-upon the received and processed customer information and product information, assigning one or more harmonization codes to the product information received from the merchant server; and, sending the harmonization codes to the merchant server. The product information may include information from the merchant as well as third-party information.

### CROSS-REFERENCE TO RELATED APPLICATIONS

This application claims the benefit of U.S. Provisional Application Ser. No. 62/630,233, filed on Feb. 13, 2018, which is incorporated herein by reference.

### TECHNICAL FIELD

The present disclosure relates to assigning six- to ten-digit harmonized and tariff codes on products for import and export. More particularly, the present disclosure relates to a method and process of assigning those codes using image analysis and machine learning, in connection with user input and post-customs clearance information.

### BACKGROUND

Differences in technology levels, currency valuations, education levels, costs of living, and other similar factors have driven different types of specialization inside various regional and sovereign economies throughout the world.

The desire of multinational businesses to optimize their profitability, and single-country businesses to optimize their supply chains, has combined with desires on the part of consumers to obtain goods that are not available in their country, or which are more cheaply available from sources outside their country, to drive trillions of dollars of imports and exports throughout the world.

Sovereign governments have historically put forth significant effort around the task of monitoring the goods which are being exported from, or imported to, their country. One consideration driving these efforts is the fact that goods which are legal in one jurisdiction may not be legal inside another jurisdiction, and therefore the second jurisdiction has an interest in preventing the import of illegal goods.

Similarly, some classes of goods are classified as pertaining to national security or viewed as being key to maintaining a country's competitive advantage in one or more areas. In these circumstances, countries prohibit the export of certain goods.

Additionally, governments have historically derived some portion of the tax revenue through levying duties and taxes upon imports from other countries. Because any given country has different industries that they are trying to expand, protect, or otherwise influence, different duty and tax rates are commonly assigned to different classifications of goods.

The differing duty and tax rates, along with the legal and security issues described above, drive a need for a common classification system that is honored by all, or substantially all, of the world's countries and which can be used to describe all possible goods which a country could desire to import or export.

The classification system which is used for import and export purposes is the Harmonized Commodity Description and Coding Systems (HS). The HS is maintained by the World Customs Organization (WCO) and consists of a series of numeric codes of up to ten digits. The first six digits of the ten-digit code are defined by the WCO. The last four digits of a given HS code are defined by the importing country. This allows for broad global standardization while also allowing each country to more narrowly define certain categories of goods according to their internal legal and regulatory requirements.

Historically, the bulk of imports and exports between countries were the result of business-to-business transactions. Both the cost of shipping and the burden of complying with the import/export laws lent itself best to large shipments of fairly homogenous goods.

Three recent trends are driving a change in the nature of global imports and exports. The increasing sophistication and efficiency of logistic companies like UPS® and FedEx® have drastically reduced the relative cost of shipping smaller packages. Additionally, the advancement of information technology has increased the speed with which items can clear customs in most countries. Finally, the rise of e-commerce has meant that it is relatively simple for consumers in one country to connect with merchants in other countries—potentially even countries halfway around the world from them. While e-commerce has been the new means of purchasing goods in the market, there are problems experienced by other companies beyond e-commerce that are wanting to enter the global market, but find it prohibitive based on cost, knowledge, and resources.

These three trends have combined to make it economic for consumers to purchase small batches—possibly even single items—directly from suppliers in foreign countries, and then pay to have those goods shipped to them with the reasonable expectation that the goods will clear customs in hours or days rather than weeks or months.

This ever-increasing flow of e-commerce-driven imports and exports, and the speed with which the orders are able to be processed through customs in the various countries is, just like the earlier business-to-business shipments, based-upon the accurate categorization of the various goods according to the HS system, which has introduced a substantial cost to e-commerce retailers.

The classification of items into the proper HS code is a manual process, and one that requires a significant amount of expertise to correctly assign the first six digits of the HS code. Properly selecting the last four, country-specific, digits of an HS code for a given product requires further expertise, and, like all manual processes, is expensive in comparison to automated processes which can be performed by computer systems.

The expense of classifying a particular item into the correct six-digit code has not changed significantly from the days when most imports were business-to-business. Rather than importing or exporting a small variety of items to a handful of countries, as was the case for many of the traditional import/export companies, today's e-commerce sites are faced with thousands, or even tens-of-thousands of SKUs and potential customers that can come from almost any country in the world. When one also considers that many of these companies are faced with maintaining catalogs of products that change on a frequent basis, it becomes clear that properly harmonizing their entire catalog for every possible country to which they might sell to would be a significant cost.

Even worse, in the event that the e-commerce company never sells a given item to a given country, the ten-digit classification of that particular item ends up being a wasted expense. The question of how much of their catalog to harmonize, and which countries they need to be ready to export to, is a key—and potentially very costly—decision for any e-commerce company.

There is another consideration that further complicates doing business for e-commerce companies. Given the complexity of the HS system, it is possible for two experts to classify the same item being shipped to the same country under different ten-digit HS codes. This complexity, along with concerns over purposeful misclassification of goods, means that it is common for customs agents to inspect some portion of the shipments being imported into their country.

Based on these standard inspections, where customs agents often open boxes, packages, or containers to verify the items are as described, it is not uncommon for customs to reclassify items to different HS codes with corresponding changes to how the items are taxed and the duty to which they are subject.

Under the previously existing system of international commerce, where most shipments were business-to-business, this was still problematic, but oftentimes the importer and exporter were operating with the assumption that they would have a long-term business relationship, and therefore there was some degree of willingness to negotiate a split of the difference between the expected duties and taxes and the revised duties and taxes under the new HS code.

Furthermore, the fact that all other importers into a given country would be subject to the same duties and taxes on that particular item, assuming consistent application of the HS codes, meant that the duties and taxes could largely be passed on to the retail consumers. In effect, any uncertainty around the importation costs was acceptable inside a certain band because the price to the end customer had not yet been established.

E-commerce retailers, by and large, do not have the same flexibility. Their retail customers want to know a final, landed cost, including all fees required to get it to their doorstep at the time that they place the order; and very few, if any, of the retail customers have the expertise required to correctly estimate the amount of duties and taxes that will be assessed on the item they are wishing to purchase from the e-commerce retailer.

Early e-commerce sites typically showed a product's cost and a shipping cost, but did not make any attempt to establish duties and taxes for the retail customer, instead leaving the import costs in the hands of the retail customer.

This was often problematic. When the actual duties and tax were different than what the retail customer was expecting, either because no estimate was provided by the e-commerce site, or because the estimate was wrong, customers would often refuse the shipment and dispute the original charge with their credit card company. This left the e-commerce company with merchandise located in a foreign country, no revenue on the original shipment, and the question of whether to pay to get the merchandise back to their country or abandon the shipment in the country to which it was originally shipped.

Even in instances where the retail customer did not refuse shipment on an order with more duties and tax than they were expecting, the situation of being faced with an unexpected charge generally discouraged the customer from making additional purchases from the e-commerce site, or to leaving a negative review of the merchant.

Because of this, it has become common for e-commerce websites to allow international retail customers to ‘prepay’ the duty and tax on their shipments. The e-commerce website collects the estimated duties and tax from the retail customer and then instructs the logistics company to bill them, rather than the customer, the actual duty and tax required by the importing country's customs agency.

Adopting this practice across the e-commerce segment has resulted in exponential growth in international e-commerce, but at the cost of the e-commerce sites assuming the cost of any discrepancies between their duty and tax estimate and the actual duties and taxes. This further emphasizes the need for e-commerce sites to be able to correctly assign a correct ten-digit HS code for the correct country for any item they are offering for sale to an international prospective customer. If a company quotes estimated duties and taxes to a store based on the wrong HS code for the retail customer's particular country, the odds dramatically increase that they will quote the wrong duty and tax amount.

In the event that the quoted duty and tax amount is too low, and the customer submits the order, then the e-commerce retailer will suffer decreased profit on the order for the difference between the quoted duties and tax and the actual duties and tax.

In the event that the quoted duty and tax amount is too high, the increased cost to the retail customer will tend to result in a decrease in conversion rates for the e-commerce site, potentially resulting in decreased profitability due to sales that otherwise would have occurred with a more accurate duties and tax quote.

While the above concerns are most vividly highlighted in an e-commerce site-to-retail customer model, it is important to note that business-to-business transactions are moving more and more to a model that can be all but indistinguishable from e-commerce sales to retail customers. A website located in one country, which sells automotive parts to a retail customer in a second country, can, on the same day, process transactions for a wholesaler in a third country.

This, combined with the same trends towards smaller shipment sizes and increased speed for clearing customs, means that the concerns and problems which have been enumerated with regards e-commerce sites selling to retail customers are also present to some extent in all international purchases.

Finally, even once a company's product catalog has been harmonized, there is no good method for determining a level of confidence around the accuracy of any particular six- or ten-digit HS code. Depending on the individual making the assignments and their expertise, both generally and specifically around that particular type of product and the countries they are assigning HS codes for, a company may experience wildly differing levels of accuracy with regards to the HS codes inside their harmonized catalog.

Because of the past and current nature of assigning an HS code, only those with extensive training and knowledge were able to validate the accuracy of the code assigned to the appropriate goods or products. Lack of that knowledge prohibits easy entry into the global market for e-commerce or any business desiring access.

Due to the aforementioned problems, there exists a need for an improved method for assigning items the proper ten-digit HS code, which is automated, and which may be updated on a consistent basis with re-classification information when received from any country's given custom's agency.

### SUMMARY OF EXAMPLE EMBODIMENTS

In one embodiment, a method for determining HS codes is set forth whereby the codes are dynamically assigned for a given quote to a given potential customer in real-time, rather than needing to be assigned before the arrival of a prospective customer on the e-commerce website.

In one embodiment, confidence ratings are established for HS codes.

In one embodiment, a method comprises aggregating identical or substantially similar products across different retailers based-upon key data points for purposes of assigning HS codes.

In one embodiment, a method comprises assigning an HS code based-upon multiple, aggregated data points.

In one embodiment, a method comprises weighting differing data points depending upon the industry, country, product description, image, and other key characteristics.

In one embodiment, a method comprises improving the accuracy of assigned HS codes by incorporating corrective feedback from a variety of sources.

In one embodiment, a method comprises establishing a relevancy weighting system for sources of external, corrective HS classification information.

In one embodiment, a method comprises communicating HS code information on ordered items to the logistics company which will be used to clear the item through customs.

In one embodiment, a method comprises communicating the HS code, along with other relevant data, to the customs broker or customs agent for final validation of the HS code.

### BRIEF DESCRIPTION OF THE DRAWINGS

FIG. 1 illustrates a method for processing international orders and dynamically assigning HS codes to products as needed, rather than in advance;

FIG. 2 illustrates a harmonization application capable of classifying items according to the appropriate HS code and programmatically improving the accuracy of results over time; and

FIG. 3 illustrates a flow chart implementing a method of dynamically assigning HS codes to merchant products.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there remains a need to more efficiently and accurately assign HS codes to a variety of products. Further, there is a need to do so in a fashion that allows harmonized codes to be assigned to an item only if an international customer is considering making a purchase of the item in question, and for the assignment to include both a defined confidence level and a method for programmatically correcting items which have been assigned the wrong HS code.

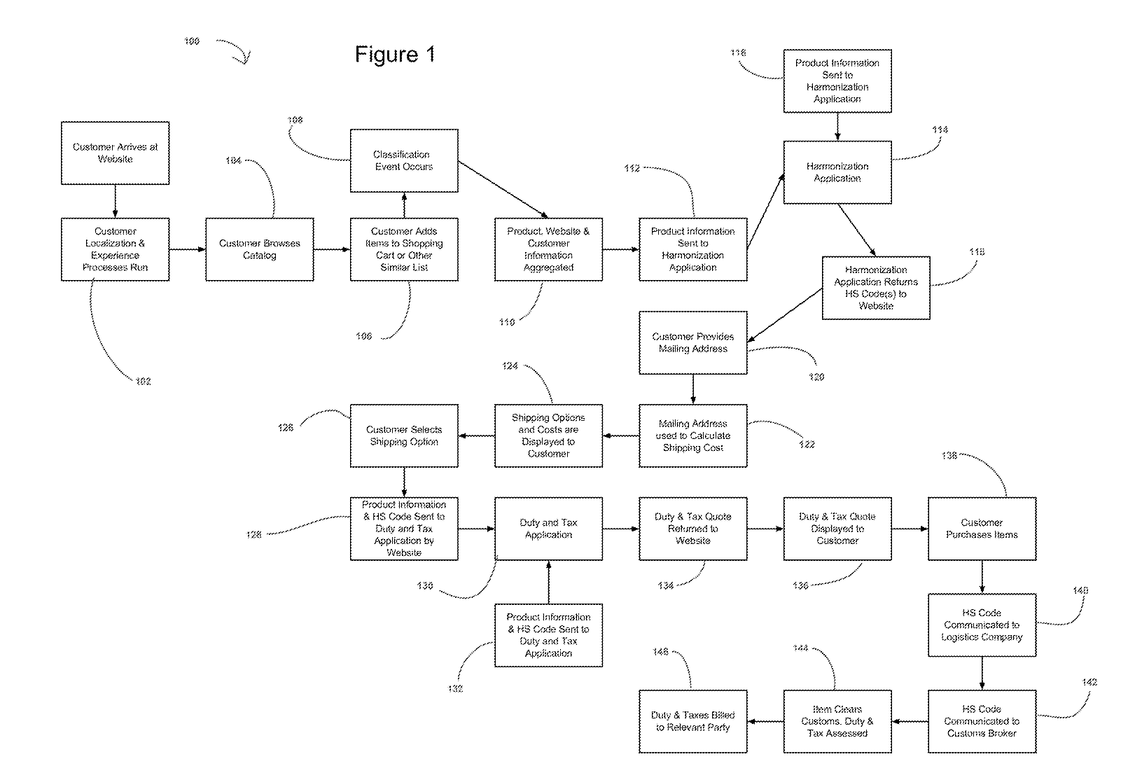

FIG. 1 illustrates, in one embodiment, a process map 100 for transacting international purchases. A customer arrives at a website which offers merchandise for purchase. Customer experience and localization processes 102 are executed. The customer experience and localization processes 102 comprise a number of processes designed to improve the customer shopping experience. Those processes may include, but are not limited to, the use of the customer's IP address to determine the customer's country of residence (localization), matching of the customer's IP address, cookies, or other identity establishing tokens to past orders submitted on the website for purposes of pre-populating data fields including, but not limited to customer name and customer address. The customer experience and localization process 102 may also include using various publicly available data points, such as the default browser language on the customer's computer to establish a preferred language for the customer, which can then be used to translate some, or all, of the text on the website to the customer's preferred language. The customer then browses the items available for sale in step 104, and may eventually add certain items into a shopping cart, or other similar list, in step 106, which is designed to group items for purchase or later perusal.

Those familiar with the current art will appreciate that while the localization process 102 is displayed as a single event occurring before the browsing of the catalog 104, it may in fact be a series of events which take place at a variety of points in the process before, after, or during the browsing of the catalog 104. After adding items to a shopping cart 106, the customer may click a checkout or purchase button, or some other classification event 108 may occur. The classification event 108 is displayed as occurring after the addition of items to a shopping cart 106 because that most resembles the current art; however, classification events 108 could, in certain circumstances and systems, be set to occur at an earlier stage in the process, up to, and including, a partial harmonization where a six-digit HS code is assigned to a product before the arrival of a customer, and an eight- or ten-digit code is assigned at some point after the customer arrives at the site and is localized in step 102. Once the classification event 108 occurs, relevant product, store, and customer information is aggregated or packaged in step 110, and then sent or transmitted in 112 to a harmonization application 114 along with the number of harmonized codes (HS codes) that the website desires to be returned. The aggregation of customer and product information 110 would include all items necessary or useful in assigning an HS code, including but not limited to, SKU, destination country, item image, UPC, item description, and country of origin. Some relevant, non-customer product information 116 may have also been sent to the harmonization application 114 previous to the customer arriving on the website, or the aggregate of all necessary information for determining an HS code may arrive via 112 after classification event 108 occurs.

The harmonization application 114 then returns one or more HS codes of six to ten digits via process 118. Ideally, the harmonization application 114 also includes one or more confidence ratings corresponding to the returned HS codes, but even just the return of one or more HS codes is a major improvement on the prior art. The customer providing a shipping address 120 is shown as occurring after the return of the HS code(s) 118; however, it could take place at a number of spots earlier in the process, or for customers who have been localized in 102 as being in countries where logistics providers charge the same rate for delivery to any part of the country, it could occur as the last event before the purchase is finalized. Once HS codes have been returned in step 118, and any needed shipping information has been obtained in 120, costs are calculated in 122 for one or more shipping options. The shipping options, and corresponding costs, are displayed to the customer in 124 and the customer selects a shipping option 126.

For each item to be purchased, the HS code returned previously in 118, or the code viewed to be most accurate by the website in the event that more than one HS code per item was returned in 118, is then sent in step 128 along with relevant product information, to a duty and tax application 130. The information included in 128 would be all items useful or required in determining the correct duty and tax for a shipment, including but not limited to the HS code(s), item values, shipping cost, and destination country. Some relevant product information may have also been sent, in step 132, to the duty and tax application 130 previous to the customer arriving on the website, or the aggregate of all necessary information for determining an HS code may arrive via 128. The duty and tax quote is then returned to the requesting website 134. The duty and tax cost is displayed to the customer in 136, and in the event that the customer purchases the item(s) in 138, the HS code and shipping method is communicated to the logistics company in 140. The HS code is communicated to the customs broker 142, allowing it to clear customs 144, during which the actual duty and tax is established and then billed to the relevant party 146.

As appreciated from the foregoing, a number of problems are solved using this method. For example, a merchant does not need to incur the cost of assigning an HS code for every item listed for sale, and, the merchant and/or the consumer is fully-aware of the duties and taxes prior to the purchase by the consumer. As a result, more purchases are completed with fewer issues at customs, which creates a higher profit for the merchant, among other benefits.

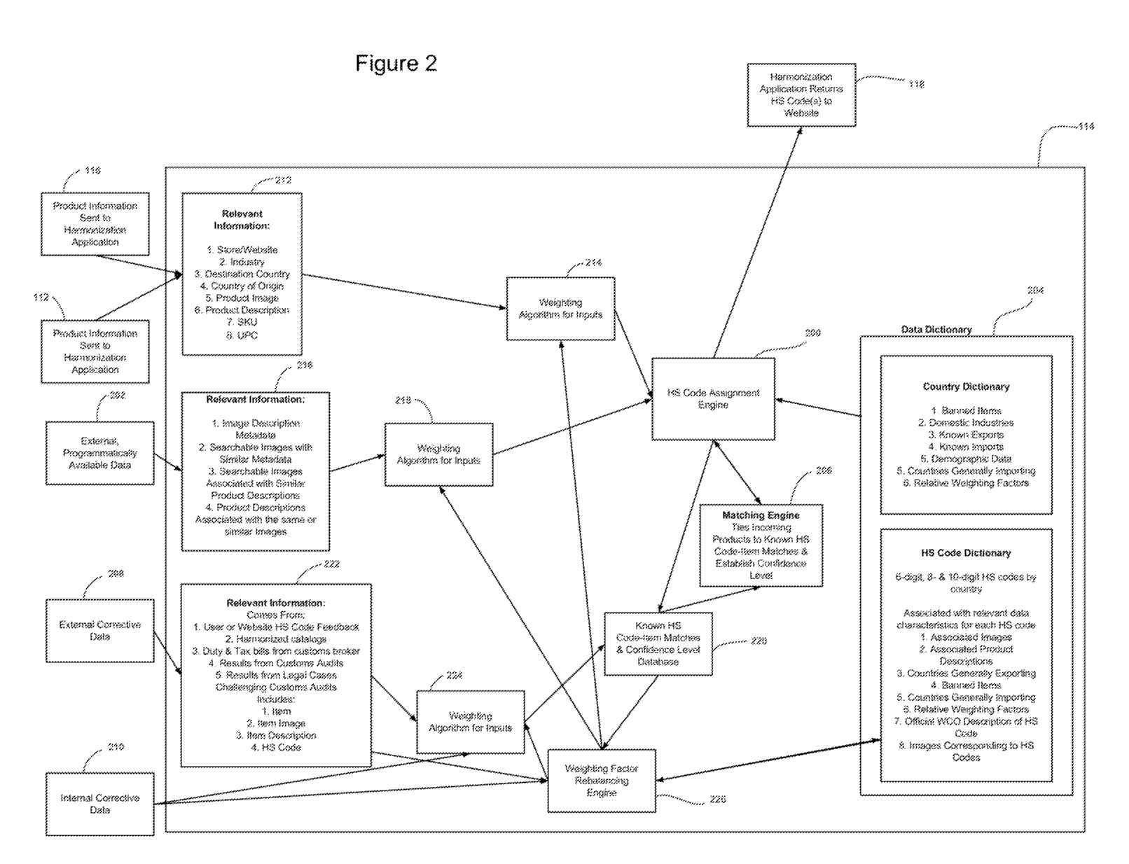

FIG. 2 illustrates, in one embodiment, a harmonization application 114 which is capable of programmatically assigning HS codes to items in real-time without human intervention at the time the HS code is issued. The harmonization application 114 is further able to improve the accuracy of the assigned HS codes over time via machine learning. The harmonization application 114 comprises an HS code assignment engine 200 (supplied directly with data sent by sellers of goods in real-time as customers are considering purchasing items 112), external data 202, a data dictionary 204, and a matching engine 206. The HS code assignment engine 200 is also indirectly supplied with external corrective data 208, and may be directly supplied with product information 116 from the sellers of the good prior to customers needing HS codes assigned for items, and indirectly supplied with internal corrective data 210. The HS code assignment engine 200 returns HS codes and confidence ratings to the calling application via process 118. The product information 112 and non-customer product information 116 comprises information 212 relevant to determining HS codes; such information may include, but is not limited to, the merchant requesting the HS code, the industry in which the merchant is engaged, the destination country, the country of origin, the product image, product description, and SKU.

The relevant information 212 is fed into a weighting algorithm, or weighting engine 214, which assigns differing relative importance for the data depending on key data points. The results and weighting are then fed into the HS code assignment engine 200. In a pair of non-limiting examples around the function of the weighting algorithm 214, certain brands of goods might have a product set that is so narrow as to result in all items sold under that brand-name being assigned the same six-digit HS code. In instances where that brand-name was included in the product description inside of the data 212, the weighting algorithm 214 would apply greatly increased significance to the product description as compared to the seller's SKU.

Alternatively, if a new image and product description were to be submitted by a seller for a previously-classified SKU, the weighting algorithm would weight the results towards returning the same HS code previously provided for the SKU. The external, programmatically available, data 202 comprises information 216 relevant to determining HS codes; such information including, but not limited to, the image description metadata, searchable images with similar metadata, searchable images associated with similar product descriptions, and product descriptions associated with the same or similar images. The relevant information 216 is fed into a weighting algorithm or weighting engine 218 which assigns differing relative importance for the data depending on key data points. The results and weighting are then fed into the HS code assignment engine 200. The data dictionary 204 comprises a variety of useful data, including but not limited to, HS code information, country information, and weighting factors that contribute to the HS code assignment engine 200 being able to provide one or more HS codes for each submitted item, and a confidence rating for each HS code. The matching engine 206 is fed by both the HS code assignment engine 200 and a database 220 of previously evaluated items along with the HS codes that were returned for each item and the confidence level surrounding each assignment. The matching engine 206 attempts to match items coming into the HS code assignment engine 200 to items in the database 220, and returns both a suggested HS code assignment and relative confidence rating for incoming items. As a non-limiting example, if an item coming into the HS code assignment engine 200 is matched to an item from the database 220 that has the same image and the same product description, and a very high confidence around the previously-returned HS code on the item in the database 220, then the matching engine 206 would return the HS code from the matched item in the database 220 and would associate a high confidence rating to the HS code that was fed into the HS code assignment engine 200.

The external corrective data 208 comprises relevant information 222 that includes, but is not limited to, the item being corrected, the description and image of the item being corrected, the corrected HS code, and the source of the correction. The relevant information 222 is fed into a weighting algorithm or weighting engine 224 which assigns differing confidence ratings to the correction data depending upon the source of the data. As a non-limiting example, data resulting from the successful legal challenge of a customs ruling would be considered to be more authoritative and receive a higher confidence rating than unchallenged customs rulings. The results from the weighting algorithm 224 are then fed into the database 220 to improve the dataset inside of the database 220.

The relevant information 222 is also fed into the weighting factor rebalancing engine 226. The weighting factor rebalancing engine 226 also receives internal corrective data 210 (e.g., corrections to matches in the database 220 that are input by HS code experts at the company managing the harmonization application 114), the database 220, and the data dictionary 204. The purpose of the weighting factor rebalancing engine 226 is to adjust the rules used to create weighting factors by the weighting algorithms 214, 218, 224, and the data dictionary 204. This is done by comparing corrective data 208 and 210 to previously matched items in the database 220 that are incorrect, and adjusting the various weighting factors in such a way as to drive the correct HS code result the next time a similar item is encountered. Those skilled in the art will appreciate that the above functions could be logically separated into a greater number of modules for greater detail, or combined into fewer modules without losing functionality. Furthermore, those skilled in the art will appreciate that while the exemplary embodiment is described as a single system with multiple data inputs and programmatic steps required in order to accurately generate an HS code and/or confidence level, the current art requires a very manual process for evaluating items and HS codes, and therefore a lesser system involving only some of the exemplary steps is still a major improvement in the art.

As an example, an e-commerce merchant may utilize the above processes to ensure correct assignment of HS codes without the need to hire an HS assignment professional. The merchant could deploy the above-disclosed systems and processes either in-house, or via third-party. In one example, the merchant would connect his e-commerce site to the systems disclosed above, which are operated by a third-party. Once connected, the third-party system is able to call the information directly from the merchant's website without any active steps by the customer or merchant. The third-party is able to assign the appropriate HS to the items in the consumer's cart, and thereby determine the duties and taxes for that particular purchaser. The ability to assign HS codes on an as-needed, per-customer basis is a significant improvement over the prior art. Further, the ability of the systems to be corrected according to outside input (e.g., custom's classification, court classification, etc.) makes the system up-to-date and relevant at all times. Therefore, it is apparent from the above disclosure that the systems and processes disclosed herein solve the need to more efficiently and accurately assign HS codes to a variety of products, to do so in a fashion that allows harmonized codes to be assigned to an item only if an international customer is considering making a purchase of the item in question, and for the assignment to include both a defined confidence level and a method for programmatically correcting items which have been assigned the wrong HS code.

A method for dynamic classification of harmonized codes comprises a harmonization server receiving public user information (e.g., IP address, browser language) to determine user location and language; receiving product information (e.g., SKU, image metadata, UPC, product description) regarding user-selected products (such as in-cart); matching user-selected products to harmonized codes in a database via a matching engine; determining accuracy of assigned harmonized codes via a harmonized code assignment engine; assigning a confidence rating (e.g., scale of 1-10, 1 being not confident and 10 being extremely confident) to the assigned harmonized code; returning the harmonized code to the merchant; and using the harmonized code to determine duties and taxes based upon the user's inputted shipping address. Non-merchant product information for determining duties and taxes may also be used, such as third-party harmonization information. The assigned harmonized code, duties, and taxes may be communicated to the selected logistics company, either via the merchant server or via the harmonization server. The harmonized code may also be communicated to a customs broker.

A system for dynamic classification of harmonized codes comprises a harmonization application in communication with a merchant server, the harmonization application receiving, storing, and processing product information; receiving and processing merchant information; receiving and processing product corrective data; weighing the importance of the received product information and corrective data; assigning a harmonization code to one or more products based-upon the processed and weighed product information and corrective data; and assigning a confidence rating to the harmonization code assigned to one or more products based upon the product information received and processed. The product information may comprise SKU, image, UPC, description metadata, and product description, among others. The merchant information may comprise country of origin, website, and other information. The product corrective data may comprise harmonized catalogs, duty and tax bills from customs brokers, and results from customs audits.

A system for dynamic classification of harmonized codes comprises a harmonization server in communication with a merchant server, the harmonization server receiving and processing customer information and product information from the merchant server; based-upon the received and processed customer information and product information, assigning one or more harmonization codes to the product information received from the server; and, sending the harmonization codes to the merchant server. In one embodiment, the harmonization server comprises a harmonization application for receiving and processing customer and product information.

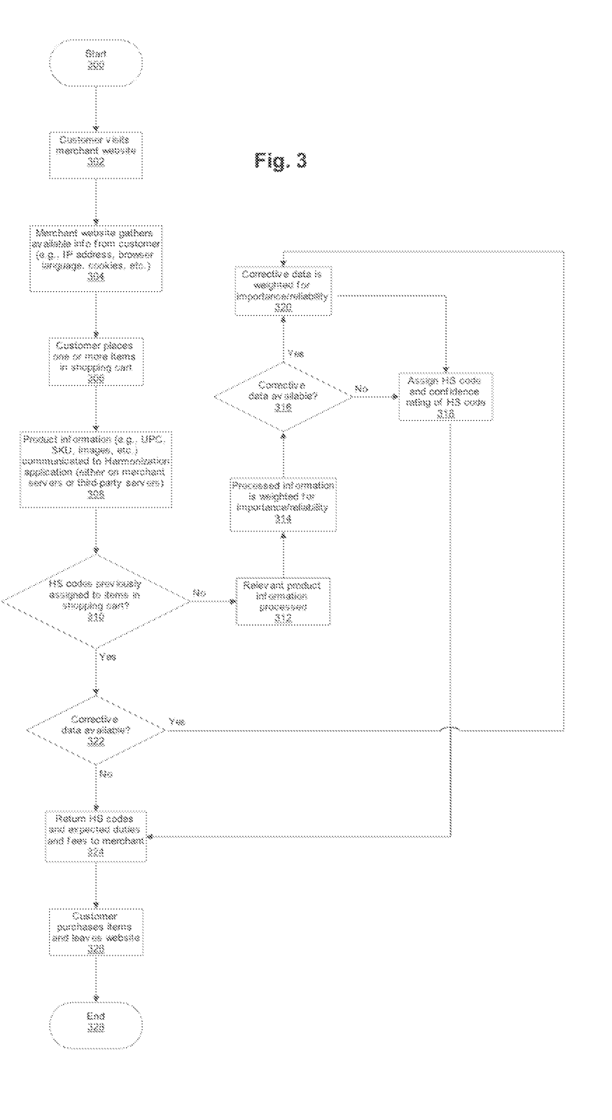

FIG. 3 illustrates one example of use. The customer visits a merchant website in 302. In 304, the merchant website gathers information about the customer using the customer's IP address, browser information, cookie information, customer submitted data if a returning customer, etc. In step 306, the customer places one or more items in the online shopping cart. In step 308, the customer information and product information, such as the UPC, SKU, images, etc., are communicated to the harmonization application 114. In step 310, if the harmonization application 114 checks a database to determine if the products match products previously assigned an HS code (for example, by a prior customer visit or by direct entry of a merchant or third-party). If an HS code has not been previously assigned, then the relevant product information is processed in step 312. In step 314, the product information is weighted. For example, UPC information may be given greater weight than the general category of good. In step 316, the harmonization application checks to see if any corrective information is available for the product. If not, then in step 318 the HS code is assigned and a confidence rating is assigned based-upon the processed information and corrective data that was available to make the HS code assignment. The process then continues to step 324. However, if corrective information is available, such as customs reclassification information or court proceeding information, that information is also processed and weighted in step 320 before the HS code is assigned in step 318. Once assigned, 324 the HS codes and/or expected duties and fees are returned to the merchant in step 324.

Returning to step 322, if corrective data is not available, the HS codes and/or expected duties and fees are returned to the merchant in step 324. The merchant website updates the total cost for the customer and the customer purchases the products in step 326. It will be appreciated that while FIG. 3 demonstrates a particular order, such order is not required. For example, the harmonization may check for corrective data as a first step, rather than a subsequent step.

Accordingly, the system and method for dynamic classification of harmonized codes solves the need for more efficiently and accurately assigning HS codes to a variety of products. Further, the system and methods disclosed herein do so in a fashion that allows harmonized codes to be assigned to an item only if an international customer is considering making a purchase of the item in question, and for the assignment to include both a defined confidence level (or rating) and a method for programmatically correcting items which have been assigned the wrong HS code.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A method for dynamic classification of harmonized codes, the method comprising:
receiving user information to determine user location and language;
receiving product information regarding user-selected products;
matching user-selected products to harmonized codes in a database via a matching engine;
determining accuracy of assigned harmonized codes via a harmonized code assignment engine;
assigning a confidence rating to the assigned harmonized code;
returning the harmonized code to the merchant; and
using the harmonized code to determine duties and taxes based upon the user's inputted shipping address.

2. The method of claim 1, further comprising receiving non-merchant product information for determining duties and taxes.

3. The method of claim 1, further comprising communicating the assigned harmonized code, duties, and taxes to the selected logistics company.

4. The method of claim 4, wherein the harmonized code is communicated to a customs broker.

5. A system for dynamic classification of harmonized codes, the system comprising:
a harmonization application in communication with a merchant server, the harmonization application:
i. receiving, storing, and processing product information;
ii. receiving and processing merchant information;
iii. receiving and processing product corrective data;
iv. weighing the importance of the received product information and corrective data;
v. assigning a harmonization code to one or more products based-upon the processed and weighed product information and corrective data; and
vi. assigning a confidence rating to the harmonization code assigned to one or more products based upon the product information received and processed.

6. The system of claim 5, wherein the product information comprises SKU, image, UPC, description metadata, and product description.

7. The system of claim 5, wherein the merchant information comprises country of origin/

8. The system of claim 5, wherein the product corrective data comprises harmonized catalogs, duty and tax bills from customs brokers, and results from customs audits.

9. A system for dynamic classification of harmonized codes, the system comprising:
a harmonization server in communication with a merchant server, the harmonization server receiving and processing customer information and product information from the merchant server;
based-upon the received and processed customer information and product information, assigning one or more harmonization codes to the product information received from the server; and
sending the harmonization codes to the merchant server.

10. The system of claim 9, wherein the harmonization server comprises a harmonization application, the harmonization application:
i. receiving, storing, and processing product information;
ii. receiving and processing merchant information;
iii. receiving and processing product corrective data;
iv. weighing the importance of the received product information and corrective data;
v. assigning a harmonization code to one or more products based-upon the processed and weighed product information and corrective data; and
vi. assigning a confidence rating to the harmonization code assigned to one or more products based upon the product information received and processed.
